(19) United States
(12) Patent Application Publication
(10) Pub. No.: US 2025/0382805 A1
(43) Pub. Date: Dec. 18, 2025

(54) SUBSEQUENT PLACING OF EARTHING POINTS

(71) Applicant: SIKA TECHNOLOGY AG, Baar (CH)

(72) Inventor: Henry HEINRICH, Malsch (DE)

(73) Assignee: SIKA TECHNOLOGY AG, Baar (CH)

(21) Appl. No.: 18/877,322

(22) PCT Filed: Jun. 22, 2023
(86) PCT No.: PCT/EP2023/067003

§ 371 Date: Dec. 20, 2024

(30) Foreign Application Priority Data
Jun. 22, 2022 (EP) 22180543.5

(51) Int. Cl. E04F 15/18; H05F 3/02

(52) U.S. Cl. CPC E04F 15/181; H05F 3/025

(57) ABSTRACT

A method of adding a grounding point to a preexisting dissipative coating layer includes the consequent steps of: placing an electrically conductive insert into a preexisting dissipative coating layer; placing an electrically conductive layer on the preexisting dissipative coating layer in proximity of the conductive insert; fastening the electrically conductive layer to the electrically conductive insert; connecting the electrically conductive layer and/or the electrically conductive insert to an equipotential bonding. The method is for a safe and fast installation of additional grounding points for a preexisting dissipative coating or system without removing the preexisting dissipative coating or system.

### TECHNICAL FIELD

The invention relates to a method for adding earthing points to dissipative coating systems, especially dissipative floor coating systems.

### PRIOR ART

Many segments of industry nowadays impose exacting requirements on optimum ambient conditions. Of the utmost importance in this context, in particular, is the prevention of uncontrolled electrostatic charging and discharge.

Electrostatic charging and discharge comes about as a result of contact, friction or separation of two materials. In the process, one material is positively charged, and the other negatively charged. In the case of floor coatings, this charge is generated by foot traffic or wheeled traffic, with rubber soles or rubber wheels, for example. Charging may also result from sweeping air on insulating surfaces, e.g., paints or coatings.

In sensitive areas, therefore, the requirement is for floors and walls with low resistances to ground, which dissipate electrostatic charging immediately and in a controlled manner. For electrostatically dissipative coatings of this kind, there are numerus standards in existence, containing test methods for assessing coatings for their suitability in respect of electrostatic or electrical behavior.

DIN EN 61340-4-1:2016-04, for example, describes test methods for determining the electrical resistance of floor coverings and laid floors. In DIN EN 61340-4-5:2019-04, the electrostatic safety is evaluated in combination with regard to the electrical resistance and the chargeability of people, footwear, and floor coverings.

There are coating systems known with ESD protection (ESD=“electrostatic discharge”), i.e., with protection from electrostatic discharge. Employed normally are dissipative systems based on epoxy resin or polyurethane.

Floors made from synthetic resins are commonly not conductive or dissipative. There are, nevertheless, several options for achieving ESD properties.

First of all, solid conductive particles of electroconductive carbon black, for example, may be added to the synthetic resin composition in order to achieve conductivity.

Another option is to use ionic liquids or to use organic salts which are soluble in the synthetic resin matrix, and which provide sufficient electrical conductivity.

A further option is the addition of carbon fibers or carbon nanotubes to the synthetic resin composition in order to achieve conductivity.

WO 2014/108310 A1 describes multicomponent compositions for a dissipative floor coating system, on a substrate for protection against electrostatic discharge and to a method for the production thereof.

In the state of the art, a dissipative coating is applied on top of a non-dissipative substrate, typically a non-dissipative synthetic resin layer. However, before the application of the dissipative coating, a grounding device for grounding the coating system must be installed on top of the non-dissipative substrate. For electrically connecting the electrostatically dissipative coating, the grounding device is connected to the equipotential bonding/ground potential.

Such grounding devices are known to the person skilled in the art, and such a person can readily implement them. The grounding device can, for example, be formed by a grounding conductor or an arrangement of grounding conductors, which are connected to the equipotential bonding. The bonding to the equipotential bonding or ground potential can take place via one or more grounding connections.

Suitable grounding conductors include, for example, copper tapes and/or so-called conductor sets, which are installed to dissipate the potential. Self-adhesive copper strips may be used, which can be applied in a simple manner to a non-dissipative layer. Conductor sets are commercially available; for example, the Sikafloor® Conductive Set. The conductor set is made up of copper tapes, washers and a threaded rod. In this way a so-called grounding point is established. This can be seen for example in the FIGS. 1-3. After the application and curing of the dissipative coating this grounding point can be connected to ground by a skilled electrician (FIG. 4).

However, in the state of the art, these grounding conductors and therefore grounding points are set up before the application of the dissipative coating.

Currently there is no solution to provide additional grounding points for a preexisting dissipative coating or system without removing the preexisting dissipative coating. It would be an important advantage if an existing preexisting dissipative coating like an ESD floor could be subsequently connected to earth.

### SUMMARY OF THE INVENTION

The object of the invention was therefore that of providing a method for a safe and fast installation of additional grounding points for a preexisting dissipative coating or system without removing the preexisting dissipative coating or system.

The invention therefore relates to a method of adding a grounding point to a preexisting dissipative coating layer, comprising the consequent steps of:
i. placing an electrically conductive insert (1) into a preexisting dissipative coating layer (2);
ii. placing an electrically conductive layer (3) on the preexisting dissipative coating layer (2) in proximity of the conductive insert (1);
iii. fastening the electrically conductive layer (3) to the electrically conductive insert (1);
iv. connecting the electrically conductive layer (3) and/or the electrically conductive insert (1) to an equipotential bonding.

Equipotential bonding, ground potential or earth are used in this document as a reference point in an electrical circuit from which voltages are measured, a common return path for electric current, or a direct physical connection to the ground.

Preferred embodiments of the composition are reproduced in the dependent claims. The invention is elucidated comprehensively below.

### BRIEF DESCRIPTION OF THE DRAWING

FIG. 1-FIG. 4: Installation of a grounding point during the application of an ESD coating system according to the state of the art.

FIG. 5-FIG. 12: Addition of a grounding point to a preexisting ESD coating system according to the invention.

### A CERTAIN EMBODIMENT OF THE INVENTION

Preferably, the term “electrically conductive” used in this document means an electrical conductivity at 20° C. of more than 10⁴ S/m, preferably more than 10⁵ S/m.

Dissipative coating layers may also be referred to as electrostatically dissipative coats. Relative to non-dissipative or insulating coats, they allow electrostatic charge which develops to be conducted away. For this purpose, dissipative coats possess a certain electrical conductivity. Dissipative and non-dissipative coats are known to the person skilled in the art.

The dissipative capacity of a preexisting dissipative coating layer (2) may be determined, for example, via the resistance to ground of the layer. As used here and unless indicated otherwise, the resistance to ground of a preexisting dissipative coating layer (2) is preferably determined in accordance with the standard DIN EN 61340-4-1:2016-04. Here, and in accordance with standards DIN EN 61340-4-1:2016-04 and DIN EN 61340-5-1:2017-07, a coating layer is deemed dissipative or electrostatically dissipative if it has a resistance to ground of less than 10⁹ ohms. Coating layers having a greater resistance to ground are not dissipative. More preferably, the coating layer has a resistance to ground of 10⁴ to 10⁸ ohms, most preferably 10⁶ to 10⁷ ohms.

The resistance to ground is determined here for the coating layer which are in installed form, as described in DIN EN 61340-4-1:2016-04.

The resistance to ground and also the system resistance in accordance with the DIN EN 61340 series of standards may vary within wide ranges, provided dissipative capacity exists. The preexisting dissipative coating layer (2), for example, suitably has a resistance to ground or a system resistance of less than 10⁹ ohms and preferably not more than 5×10⁸ ohms; the resistance to ground may be situated, for example, preferably in the range from 10⁴ ohms to 5×10⁸ ohms. The voltage at which a body is permitted to acquire charge under defined conditions as described in DIN EN 61340-4-5:2019-04 (referred to as “body voltage”) is preferably limited to less than 100 volts in accordance with DIN EN 61340-5-1:2017-07.

The thickness of the preexisting dissipative coating layer (2) may likewise vary within wide ranges and may be selected according to the end application. Preferably, the preexisting dissipative coating layer (2) has a layer thickness of less than 7 mm, suitably in the range from 0.5 to 5 mm, preferably from 0.75 to 3 mm, most preferably from 1 to 2 mm.

It is preferred if the preexisting dissipative coating layer (2) is a dissipative floor coating or a dissipative floor seal coat, preferably in clean rooms, production facilities, assembly facilities, laboratories, stores, especially solvent stores, and medical rooms.

Preferably, the preexisting dissipative coating layer (2) is made of cured reaction resins or reaction resin compounds, which optionally contain one or more additives, the reaction resins that are used for the respective dissipative coating layer independently of one another being selected from the group consisting of epoxy resins, polyurethanes, polyureas, mixtures of polyurethanes and polyureas, polymethacrylates, polyacrylates and cementitious hybrid systems, especially cementitious epoxy hybrid systems and cementitious polyurethane hybrid systems. Preferably, the preexisting dissipative coating layer (2) is made of cured epoxy resins, especially 2 component epoxy resin compositions.

It is preferred if the preexisting dissipative coating layer (2) contains one more conductive additive selected from the group consisting of carbon fibers, carbon nanotubes, carbon powder, graphite powder, silicon carbide, metal oxides, ammonium salts, heavy metal-containing or metal-containing fillers, especially antimony-and tin-containing fillers based on titanium dioxide or mica and ionic liquids, preferably selected from the group consisting of carbon fibers, carbon nanotubes, carbon powder, graphite powder, most preferably carbon fibers.

In step i), an electrically conductive insert (1) is placed into a preexisting dissipative coating layer (2). Preferably, the electrically conductive insert (1) is made of metal.

It is further preferred, if the electrically conductive insert (1) is selected from the list consisting of rod, nail and screw. Preferably the electrically conductive insert (1) is a rod, most preferably a threaded rod. It is further preferred if the electrically conductive insert (1) has a length of 40-100 mm, preferably 50-70 mm and a diameter of 4-10 mm, preferably 5-7 mm.

It is advantageous if in step i) the electrically conductive insert (1) is placed into the preexisting dissipative coating layer (2) by drilling a hole (4) into the preexisting dissipative coating layer (2) and placing the electrically conductive insert (1) into said hole (4).

Preferably the hole (4) has a diameter of 4 mm-12 mm, preferably 6 mm-10 mm, and a depth of more than >40 mm, preferably >50 mm, more preferably from >50 mm-100 mm. Preferably the hole (4) penetrates the entire thickness of the preexisting dissipative coating layer (2).

In step ii), an electrically conductive layer (3) is placed on the preexisting dissipative coating layer (2) in proximity of the conductive insert (1).

The electrically conductive layer (3) serves to provide good electrical transfer between the electrically conductive insert (1) and the preexisting dissipative coating layer (2). Preferably, the electrically conductive layer (3) is made of metal.

It is further preferred if the conductive layer (3) is a washer, preferably with a diameter of 10 mm-100 mm, preferably 20 mm-80 mm, more preferably 40 mm-80 mm.

It can be advantageous if the electrically conductive insert (1) is in direct contact with the electrically conductive layer (3).

It can also be advantageous if an electrically conductive material (5) is placed in direct contact with the preexisting dissipative coating layer (2) and the electrically conductive layer (3) and/or the electrically conductive insert (1).

Preferably, such an electrically conductive material (5) is selected from the group consisting of electrically conductive powder, preferably metal powder of graphite powder, electrically conductive tape, preferably metal or adhesive tape, and electrically conductive coatings, preferably selected from the group consisting of graphite powder and electrically conductive coatings.

The electrically conductive coatings are preferably electrically conductive coatings containing electroconductive carbon black and epoxy-based coating. Another preferred electrically conductive coating are paste-like electrically conductive coatings containing conductive powder, preferably metal powder of graphite powder, more preferably conductive metal powder, most preferably copper powder.

More preferably, the electrically conductive material (5) is selected from the group consisting of graphite powder and electrically conductive coatings, whereby the preferred electrically conductive coatings are selected from the group consisting of electrically conductive coatings containing electroconductive carbon black and epoxy-based coating; and paste-like electrically conductive coatings containing copper powder.

In one embodiment, the most preferred electrically conductive material (5) is an electrically conductive coating containing electroconductive carbon black and epoxy-based coating and is, for example, commercially available under the name of Sikafloor®-220 W Conductive or Sikafloor®-221 W Conductive from Sika Switzerland.

In another embodiment, the most preferred electrically conductive material (5) is a paste-like electrically conductive coatings containing copper powder and is, for example, commercially available under the name of 4404 Kontaktpaste CU from Aeronix, Germany, which is a synthetic metal-saponified paste with 50 wt.-% copper pigments. An advantage of such a system lies in the ease of application of such a paste-like electrically conductive coating. It can, for example, be applied by a syringe loaded with said paste-like electrically conductive coating. This allows accurate and fast application. If a one-component composition is used, no mixing is necessary prior to application.

As can be seen in the experimental section, the variant No. 2, using graphite powder as electrically conductive material, and the variant No. 3, using the conductive primer “Sikafloor-220 W Conductive” as electrically conductive material, lead to the best results both in the measurement of the resistance to ground and in the system test.

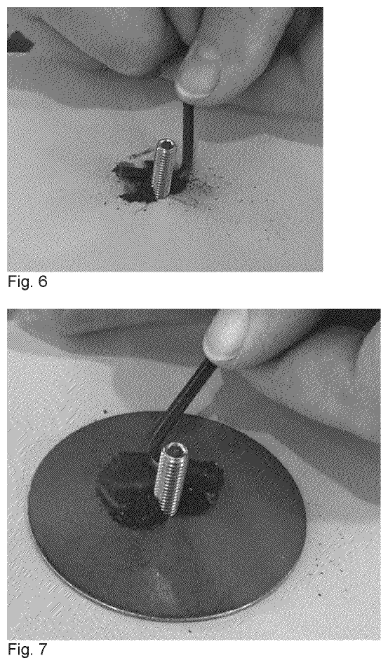

It is further preferred if the place of application of the electrically conductive material (5) is restricted to an area of less than 15 cm, preferably less than 10 cm, more preferably less than 5 cm, from the placement of the electrically conductive insert (1), most preferably it is restricted to the area of the preexisting dissipative coating layer (2) covered by the electrically conductive layer (3). This if for example shown in the FIGS. 6 and 12.

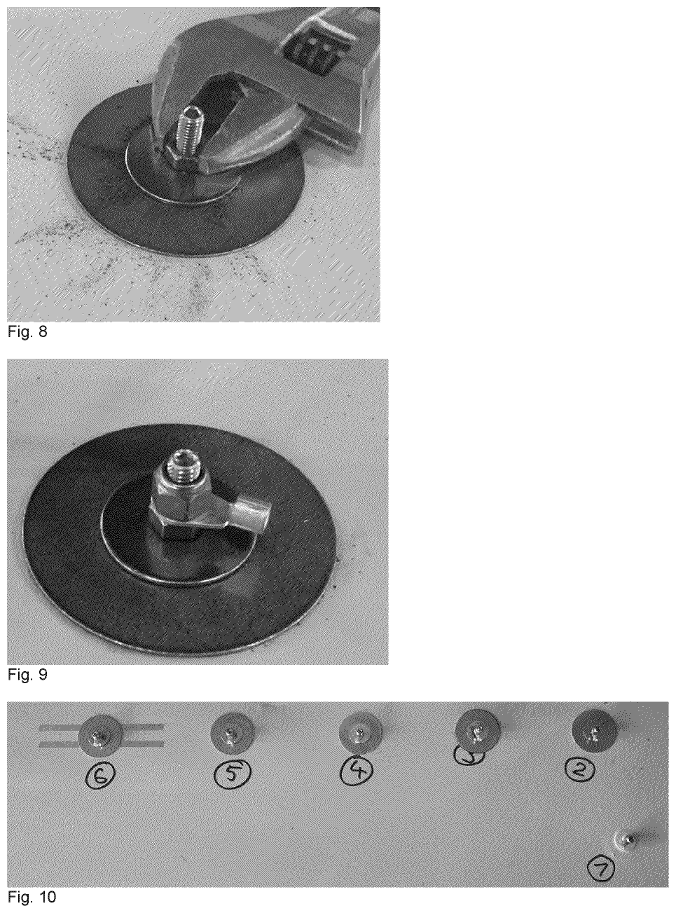

In step iii), the electrically conductive layer (3) is fastened, preferably mechanically fastened, to the electrically conductive insert (1), preferably with a nut, more preferably by fastening with a self-locking nut. This if for example shown in FIG. 8.

It is further preferred if no additional coating layer, preferably a coating layer made of cured reaction resins or reaction resin compounds, more preferably dissipative coating layer, is added on top of the electrically conductive layer (3) after step ii) has been performed, more preferably step iii) has been performed.

In a particular preferred method of adding a grounding point to a preexisting dissipative coating layer, in:
step i) a hole (4) with a diameter of 6 mm-10 mm and a depth of more than 50 mm is drilled into the preexisting dissipative coating layer (2) and a metal rod, preferably a threaded rod, is placed into said hole (4); and in
step ii) a metal washer is placed around the metal rod, preferably threaded rod, preferably with a diameter of 20 mm-80 mm, more preferably 40 mm-80 mm; and in
step iii) the metal washer is fastened to the metal rod, preferably threaded rod, by a nut; and in
step iv) the metal washer and/or the metal rod, preferably threaded rod, is connected to an equipotential bonding.

In said preferred method, it is further advantageous if an electrically conductive material (5) is placed in direct contact with the preexisting dissipative coating layer (2) and the electrically conductive layer (3) and/or the electrically conductive insert (1). The electrically conductive material (5) is preferably selected from the group consisting of graphite powder and electrically conductive coating, preferably electroconductive carbon black containing and epoxy-based coating, is added into the hole (4) or the metal rod, preferably threaded rod, before placing said metal rod into said hole (4) and/or, preferably and, said electrically conductive material (5) is placed between the metal washer and the preexisting dissipative coating layer (2).

It is further preferred, if the added grounding points that were added according to the method described before is distanced from a preexisting grounding point within a distance of 5-12 m, preferably 8-10 m. This would be advantageous if the safety range/surface of a preexisting ESD-System has to be expanded on an preexisting ESD-floor lacking the necessary preexisting grounding points. It is further preferred if each added grounding point according to the method described before is distanced from another added grounding point within a distance of 5-12 m, preferably 8-10 m.

It is also advantageous if the added grounding points that were added according to the method described before are distanced from a wall or building pillar within a distance of less than 1 m, preferably less than 0.5 m, more preferably less than 0.2 m.

Another aspect of the invention is a dissipative coating system, more particularly floor coating system, comprising an added grounding point, obtained by the method as described before.

Examples follow which elucidate the invention, but which are not intended in any way to restrict the scope of the invention.

### EXAMPLES

Commercial products used are as follows:
Sikafloor®-2350 ESD2 component epoxy ESD composition, Sika Germany.
Sikafloor®-381 ECF2 component epoxy ESD composition containing carbon fibres, Sika Germany.
Sikafloor®-220 W Conductive 2 component water-based epoxy composition, suitable as conductive film under ESD coatings, Sika Switzerland
Sikafloor®-221 W Conductive 2 component water-based epoxy composition, suitable as conductive film under ESD coatings, Sika Switzerland
Sikafloor®-151 LV 2 component epoxy composition, suitable as for primer and/or scrap coat for floor coatings, Sika Germany
Graphite powder RS PRO Graphite Schmierstoff Universal, macrocrystalline natural graphite, Pressol Schmiergeräte GmbH, Germany
Conductive tape Electrically conductive adhesive transfer tape 9713, 3M
Copper tape Copper foil adhesive tape for electrostatic conductive floors, width: 9 mm, thickness 0.1 mm.
Copper paste Synthetic metal-saponified paste with 50 wt.-% copper pigments, 4404 Kontaktpaste CU, Aeronix, Germany.

In order to investigate the performance of added grounding points to a preexisting dissipative coating layer and comparing them to originally installed grounding points, 3 different systems containing a previously installed ESD coating (Sikafloor-2350 ESD) were used. The result of the ESD-measurements are shown in table 2-4.

The same ESD-measurements were performed on a installed ESD coating containing carbon fibres (Sikafloor®-381 ECF). The results of the ESD-measurements are shown in table 5.

Thickness:
Sikafloor®-2350 ESD 1.0 mm
Sikafloor®-381 ECF 1.0 mm
Sikafloor®-220 W Conductive 0.1 mm
Sikafloor®-221 W Conductive 0.1 mm
Sikafloor®-151 LV 0.5 mm

The following types of added grounding points (No.2-6, resp. No.2a-6a or No.2b-6b) were investigated and compared to the originally installed grounding point (No.1, resp. No.1a or No. 1b).

TABLE 1

| No. | Type of added earthing point |
|---|---|
| 1 | Originally installed earthing point (applied below conductive primer and final |
| | ESD layer) |
| 2 | Earthing point laid on top of Sikafloor-2350 ESD, using graphite powder in the |
| | contact zone between the large washer and the ESD floor covering. |
| 3 | Earthing point laid on top of Sikafloor-2350 ESD, using the conductive primer |
| | “Sikafloor-220 W Conductive” in the contact zone between the large washer and |
| | the ESD floor covering |
| 4 | Earthing point laid on the Sikafloor-2350 ESD, using the conductive tape “3M ™ |
| | Electrically Conductive Tape 9713” in the contact zone between the large |
| | washer and the ESD floor covering. |
| 5 | Earthing point laid on the Sikafloor-2350 ESD, without using any conductive |
| | intermediate layer in the contact zone between the large washer and the ESD |
| | floor covering. |
| 6 | Earthing point laid on the Sikafloor-2350 ESD, using conductive copper tape in |
| | the contact zone between the large washer and the ESD floor covering. |
| 7 | Earthing point laid on the Sikafloor-2350 ESD, using conductive copper paste in |
| | the contact zone between the large washer and the ESD floor covering. |

All added earthing points No. 2-6 were installed by drilling a hole of a diameter of 8 mm and a depth of >50-70 mm into the preexisting dissipative coating layer (Sikafloor-2350 ESD). A plastic plug was inserted into the hole and a metal threaded rod (dowel rod, length 50 mm, diameter 5 mm) is placed into said hole. A metal washer a diameter of 60 mm is placed around the metal threaded rod, a smaller metal washer is placed on top and the metal washers were fastened to the metal threaded rod by a self-nut. The performance of the subsequently added grounding points were then tested by the below mentioned ESD-measurements.

FIG. 10 shows the installed earthing points No. 1-6 from the system Sikafloor-151 (SR-151)/Sikafloor-220 W Conductive (SR-220 W C)/Sikafloor-2350 ESD (SR-2350 ESD) measured in tables 2-4.

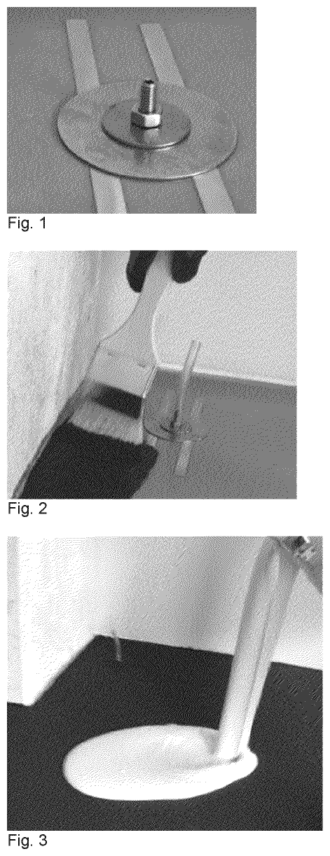

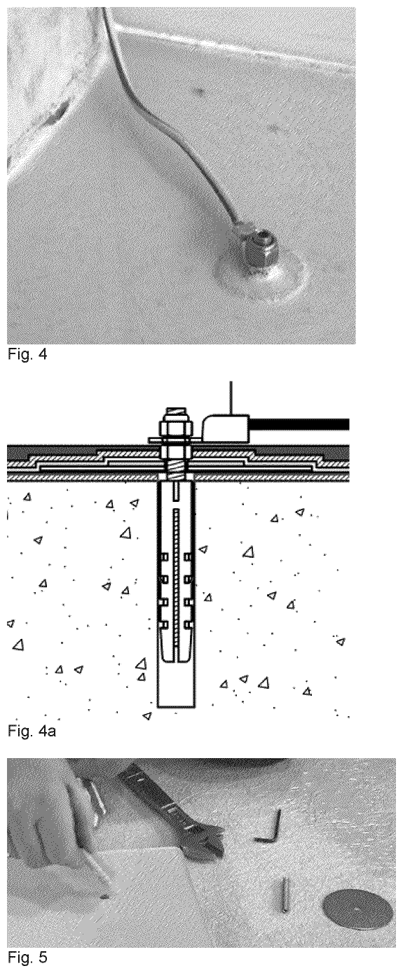

FIGS. 1-4 show steps in the installation of preexisting earthing point No. 1.

FIGS. 5-9 show steps in the installation of added earthing point No. 2 using graphite powder as electrically conductive material (5). As can be seen for example in FIGS. 8-9, the use of graphite powder has the disadvantage of accumulation of graphite powder in preexisting groves and irregulates in the the preexising ESD floor covering and the resulting visual impairment.

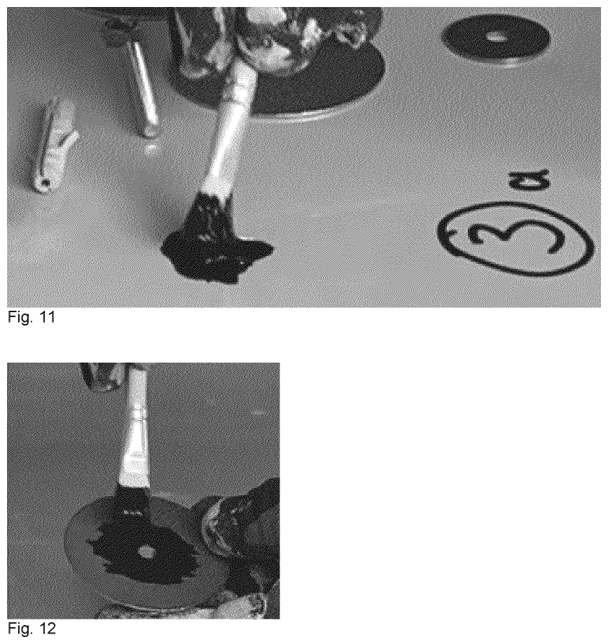

FIGS. 11-12 show steps in the installation of added earthing point No. 3 using the conductive primer “Sikafloor-220 W Conductive” as electrically conductive material (5). As can be seen in the FIGS. 11 and 12, the conductive primer is added into the drilled hole as well as on the side of the metal washer contacting the preexising ESD floor covering.

### ESD-Measurement According the Below Stated Standards

R_{G} acc. DIN EN 61340-4-1:2016-04 (Used measurement equipment: Metriso 3000 +ESD electrode Model 850 (Weight: 2.50 kg, Diameter: 65 mm, smooth rubber pad, Shore A 60)

System Resistance Test Resistance measurement in combination with a person acc. DIN EN 61340-4-5:2019-04 (Used measurement equipment: Metriso 3000+steel handle+ESD foot ware: Weeger ESD-Clog, Size 43, Item No.: 48512-30)

Walking Test (Voltage measurement in combination with a person acc. DIN EN 61340-4-5:2019-04 (Used measurement equipment: Warmbier WT 5000+steel handle+ESD foot ware: Weeger ESD-Clog, Size 43, Item No.: 48512-30)

TABLE 2
Measurement results R_{G} acc. DIN EN 61340-4-1 [<1 GΩ]

| | SR-151 | | | | SR-151 |
|---|---|---|---|---|---|
| | SR-220 W Co. | | SR-151 | | SR-221 W Co. |
| No | SR-2350 ESD | No | SR-2350 ESD | No | SR-2350 ESD |
| 1 | 436 KΩ | 1a | 12.70 MQ | 1b | 4.94 MQ |
| 2 | 545 KΩ | 2a | 13.80 MQ | 2b | 6.13 MQ |
| 3 | 325 KΩ | 3a | 11.61 MQ | 3b | 4.20 MQ |
| 4 | 498 KΩ | 4a | 14.83 MQ | 4b | 6.06 MQ |
| 5 | 752 KΩ | 5a | 14.50 MΩ | 5b | 5.29 MΩ |
| 6 | 981 KΩ | 6a | 14.00 MQ | 6b | 6.07 MQ |

TABLE 3
Measurement results System Resistance Test
DIN EN 61340-4-5 [<1 GΩ]

| | SR-151 | | | | SR-151 |
|---|---|---|---|---|---|
| | SR-220 W Co. | | SR-151 | | SR-221 W Co. |
| No | SR-2350 ESD | No | SR-2350 ESD | No | SR-2350 ESD |
| 1 | 960 KΩ | 1a | 6.74 MQ | 1b | 5.68 MQ |
| 2 | 1.09 MQ | 2a | 6.93 MΩ | 2b | 6.56 MQ |
| 3 | 1.05 MQ | 3a | 5.32 MQ | 3b | 4.53 MQ |
| 4 | 1.78 MQ | 4a | 7.29 MQ | 4b | 6.41 MΩ |
| 5 | 2.39 KΩ | 5a | 7.24 MQ | 5b | 5.70 MQ |
| 6 | 2.49 MQ | 6a | 7.79 MQ | 6b | 6.83 MQ |

TABLE 4
Measurement results Walking Test acc. DIN EN 61340-4-5 [<100 Volt]

| | SR-151 | | | | SR-151 |
|---|---|---|---|---|---|
| | SR-220 W Co. | | SR-151 | | SR-221 W Co. |
| No | SR-2350 ESD | No | SR-2350 ESD | No | SR-2350 ESD |
| 1 | Average peaks: −20.87 Volt | 1a | Average peaks: −18.56 Volt | 1b | Average peaks: −19.35 Volt |
| | Average valleys: −13.09 Volt | | Average valleys: −10.82 Volt | | Average valleys: −11.23 Volt |
| 2 | Average peaks: −20.95 Volt | 2a | Average peaks: −21.40 Volt | 2b | Average peaks: −15.99 Volt |
| | Average valleys: −20.87 Volt | | Average valleys: −9.87 Volt | | Average valleys: −8.98 Volt |
| 3 | Average peaks: −21.05 Volt | 3a | Average peaks: −16.11 Volt | 3b | Average peaks: −17.29 Volt |
| | Average valleys: −12.74 Volt | | Average valleys: −8.88 Volt | | Average valleys: −10.04 Volt |
| 4 | Average peaks: −20.49 Volt | 4a | Average peaks: −16.26 Volt | 4b | Average peaks: −15.97 Volt |
| | Average valleys: −11.14 Volt | | Average valleys: −9.65 Volt | | Average valleys: −9.09 Volt |
| 5 | Average peaks: −21.96 Volt | 5a | Average peaks: −18.05 Volt | 5b | Average peaks: −15.81 Volt |
| | Average valleys: −13.44 Volt | | Average valleys: −10.15 Volt | | Average valleys: −10.15 Volt |
| 6 | Average peaks: −23.19 Volt | 6a | Average peaks: −15.55 Volt | 6b | Average peaks: −15.35 Volt |
| | Average valleys: −14.79 Volt | | Average valleys: −10.31 Volt | | Average valleys: −9.00 Volt |

TABLE 5

| | | | | | | | | | | | | | Geo. | Geo. mean | |
|---|---|---|---|---|---|---|---|---|---|---|---|---|---|---|---|
| No. | SR-381 ECF | | | | | | | | | | | Ø kΩ | mean kQ | kΩ/MΩ/Volt | |
| 1 | R_{G} [kΩ] | 70 | 67 | 54 | 33 | 63 | 93 | 62 | 78 | 96 | 53 | 67 | 64 | 64 | KΩ |
| 2 | R_{G} [kΩ] | 60 | 84 | 86 | 1000000 | 94 | 82 | 45 | 56 | 42 | 80 | 100063 | 176 | 176 | KΩ |
| 3 | R_{G} [kΩ] | 83 | 3700 | 396000 | 4000 | 38 | 388000 | 67 | 39 | 87 | 54 | 79207 | 784 | 784 | KΩ |
| 4 | R_{G} [kΩ] | 1100 | 1100 | 1100 | 1200 | 1400 | 1000 | 7700 | 718000 | 5500 | 1100 | 73920 | 3072 | 3.1 | MΩ |
| 5 | R_{G} [kΩ] | 1100 | 5400 | 4100 | 2870 | 4900 | 10000 | 1100 | 1100 | 1100 | 1100 | 3277 | 2344 | 2.3 | MΩ |
| 6 | R_{G} [kΩ] | 2900 | 9100 | 4800 | 1000 | 1100 | 1000000 | 1000 | 1000 | 1100 | 1100 | 102310 | 3332 | 3.33 | MΩ |

In an additional test, the difference in performance of added grounding points using electrically conductive coatings containing electroconductive carbon black and epoxy-based coating (Sikafloor®-220 W Conductive, No.3) versus added grounding points using paste-like electrically conductive coatings containing copper powder (4404 Kontaktpaste CU, No.7) was further analyzed by measuring the R_{G} using the same set-up as described in table 2, first column (SR-151/SR-220 W Co./SR-2350 ESD). The installation of the added grounding points and ESD coating was following the same procedure as described above. The following types of added grounding points (No.3d and No.7d) were investigated and compared to the originally installed grounding point (No.1d). The result of the R_{G}-measurements are shown in table 6.

TABLE 6
Measurement results R_{G} acc. DIN EN 61340-4-1 [<1 GΩ]

| | SR-151 |
|---|---|
| | SR-220 W Co. |
| No | SR-2350 ESD |
| 1d | 523 KQ |
| 3d | 678 KΩ |
| 7d | 751 KΩ |

It was surprisingly found that the inventive method is usable for a broad range of different types of preexising ESD-coatings with different build-ups and ESD-coating compositions/types. All 6 types (No. 2-7) of added earthing points would meet the ESD requirements of DIN EN 61340-5-1 and ANSI ESD S 20.20.

It was further found that both, the variant No. 2, using graphite powder as electrically conductive material, and the variant No. 3, using the conductive primer “Sikafloor-220 W Conductive” as electrically conductive material, lead to the best results both in the measurement of the resistance to ground and in the system test.

It was further found in table 6 that both, the variant No. 7, using a paste-like electrically conductive coating containing copper powder as electrically conductive material, and the variant No. 3, using the conductive primer “Sikafloor-220 W Conductive” as electrically conductive material, lead to similar results in the measurement of the resistance to ground, being slightly superior in the case of No. 3.

1. Method of adding a grounding point to a preexisting dissipative coating layer, comprising the consequent steps of:
i) placing an electrically conductive insert into a preexisting dissipative coating layer;
ii) placing an electrically conductive layer on the preexisting dissipative coating layer in proximity of the conductive insert;
iii) fastening the electrically conductive layer to the electrically conductive insert;
iv) connecting the electrically conductive layer and/or the electrically conductive insert to an equipotential bonding.

2. Method according to claim 1, wherein the conductive layer is a washer.

3. Method according to claim 1, wherein the preexisting dissipative coating layer has a resistance to ground of less than 10⁹ ohms, determined according to DIN EN 61340-4-1:2016-04.

4. Method according claim 1, wherein the preexisting dissipative coating layer has a layer thickness of less than 7 mm.

5. Method according to claim 1, wherein the preexisting dissipative coating layer contains one more conductive additive selected from the group consisting of carbon fibers, carbon nanotubes, carbon powder, graphite powder, silicon carbide, metal oxides, ammonium salts, heavy metal-containing or metal-containing fillers.

6. Method according claim 1, wherein the term electrically conductive means an electrical conductivity at 20° C. of more than 10⁴ S/m.

7. Method according to claim 1, wherein the electrically conductive insert is selected from the list consisting of rod, nail and screw.

8. Method according to claim 1, wherein in step i) the electrically conductive insert is placed into the preexisting dissipative coating layer by drilling a hole into the preexisting dissipative coating layer and placing the electrically conductive insert into said hole.

9. Method according to claim 1, wherein an electrically conductive material is placed in direct contact with the preexisting dissipative coating layer and the electrically conductive layer and/or the electrically conductive insert.

10. Method according to claim 9, wherein the electrically conductive material is selected from the group consisting of electrically conductive powder, electrically conductive tape, and electrically conductive coatings.

11. Method according to claim 1, wherein in step iii) electrically conductive layer is mechanically fastened to the electrically conductive insert.

12. Method according to claim 1, wherein in
step i) a hole with a diameter of 6 mm-10 mm and a depth of more than 50 mm is drilled into the preexisting dissipative coating layer a metal rod is placed into said hole;
step ii) a metal washer is placed around the metal rod;
step iii) the metal washer is fastened to the metal rod, by a nut;
step iv) the metal washer and/or the metal rod, is connected to an equipotential bonding.

13. Method according to claim 12, wherein electrically conductive material, is added into the hole or the metal rod, before placing said metal rod into said hole and/or, said electrically conductive material is placed between the metal washer and the preexisting dissipative coating layer.

14. Method according to claim 1, wherein no additional coating layer, is added on top of the electrically conductive layer (3) after step ii) has been performed.

15. Method according to claim 1, wherein the added grounding points that was added according to the method is distanced from a preexisting grounding point within a distance of 5-12 m.

16. A dissipative coating system, comprising an added grounding point, obtained by the method as claimed in claim 1.
